(19) United States
(12) Patent Application Publication
(10) Pub. No.: US 2022/0189192 A1
(43) Pub. Date: Jun. 16, 2022

(54) GROWTH EVALUATION DEVICE, GROWTH EVALUATION METHOD, AND GROWTH EVALUATION PROGRAM

(71) Applicants: NH FOODS LTD., Osaka (JP); NTT DATA Corporation, Tokyo (JP)

(72) Inventors: Shin SUKEGAWA, Tsukuba-shi (JP); Daisuke UCHIDA, Tsukuba-shi (JP); Masaki OKUDA, Tsukuba-shi (JP); Tatsuki YOSHIDA, Tokyo (JP); Naoki MORITA, Tokyo (JP); Yusuke OSHIRO, Tokyo (JP)

(21) Appl. No.: 17/653,508

(22) Filed: Mar. 4, 2022

Related U.S. Application Data
(63) Continuation of application No. PCT/JP2020/033006, filed on Sep. 1, 2020.

(30) Foreign Application Priority Data
Sep. 6, 2019 (JP) 2019-162721

(51) Int. Cl. G06V 40/10; G06T 7/62; G06T 7/00; G06T 7/12; A01K 29/00

(52) U.S. Cl. CPC G06V 40/10; G06T 7/62; A01K 29/00; G06T 7/12; G06T 7/001

(57) ABSTRACT

Provided is a technology that allows easy evaluation of a degree of growth of pigs raised in a group instead of guiding the pigs one by one to a cage. A growth evaluation device includes an extraction unit that extracts, from an image captured by a camera disposed to face a pen in which the plurality of pigs are raised in the group, a buttock image having buttocks of one of the pigs facing forward, an arithmetic unit that arithmetically determines a buttock width from the buttock image, and an evaluation unit that evaluates the degree of growth of all the plurality of pigs on the basis of a prescribed number or more of the buttock widths arithmetically determined by the arithmetic unit.

### CROSS-REFERENCE TO RELATED APPLICATION

The present application is a continuation of International Application No. PCT/JP2020/033006 filed on Sep. 1, 2020, the disclosures of which are hereby incorporated in their entirety by reference.

### TECHNICAL FIELD

The present invention relates to a growth evaluation device, a growth evaluation method, and a growth evaluation program.

### BACKGROUND ART

When body weights of farm animals are to be measured, it has been required to individually guide the farm animals one by one to a cage and place each of the farm animals on a weight scale provided in the cage. A technology that uses a distance measurement device, instead of placing a farm animal on a weight scale, and converts a distance to the farm animal to a body weight or the like is also known (see, e.g., Patent Document 1).

### CITATION LIST

### Patent Document

Patent Document 1: Patent Publication JP-A-2007-175050

### SUMMARY

### Technical Problem

When pigs are raised, a method that uses cages generally referred to as pens or defined compartments to raise the pigs in groups are used in most cases. A plurality of pigs housed in each of the pens are allowed to move around relatively freely, and therefore the method is preferable in terms of health management for the pigs. However, when the body weights of the pigs in the pen are to be measured for the purpose of determining shipment and checking growth degrees, a task of guiding the pigs one by one to a cage has become a burden.

The present invention has been achieved in order to solve such a problem and provides a technology of easily evaluating growth degrees of pigs raised in a group instead of guiding the pigs one by one to a cage.

### Solution to Problem

A growth evaluation device in a first aspect of the present invention includes: an extraction unit that extracts, from an image captured by a camera disposed to face a pen in which a plurality of pigs are raised in a group, a buttock image having buttocks of one of the pigs facing forward; an arithmetic unit that arithmetically determines a buttock width from the buttock image; and an evaluation unit that evaluates a degree of growth of all the plurality of pigs on the basis of a prescribed number or more of the buttock widths arithmetically determined by the arithmetic unit.

A growth evaluation method in a second aspect of the present invention includes: an extraction step of extracting, from an image captured by a camera disposed to face a pen in which a plurality of pigs are raised, a buttock image having buttocks of one of the pigs facing forward; an arithmetic step of arithmetically determining a buttock width from the buttock image; and an evaluation step of evaluating a degree of growth of all the plurality of pigs on the basis of a prescribed number or more of the buttock widths arithmetically determined in the arithmetic step.

A growth evaluation program in a third aspect of the present invention causes a computer to execute: an extraction step of extracting, from an image captured by a camera disposed to face a pen in which a plurality of pigs are raised, a buttock image having buttocks of one of the pigs facing forward; an arithmetic step of arithmetically determining a buttock width from the buttock image; and an evaluation step of evaluating a degree of growth of all the plurality of pigs on the basis of a prescribed number or more of the buttock widths arithmetically determined in the arithmetic step.

### Advantageous Effects of Invention

According to the present invention, it is possible to provide a technology of easily evaluating growth degrees of pigs raised in a group instead of guiding the pigs one by one to a cage.

### BRIEF DESCRIPTION OF DRAWINGS

FIG. 1 is a diagram illustrating an overall view of a pig raising environment using an evaluation device according to the present embodiment.

FIG. 2 is a diagram illustrating a hardware configuration of the evaluation device.

FIG. 3 is a graph illustrating a relationship between an age in days and a buttock width of a pig.

FIG. 4 is a graph illustrating a relationship between the age in days and a body weight of the pig.

FIG. 5 is a graph illustrating the buttock width and body weight of the pig.

FIGS. 6(A) and 6(B) are diagrams illustrating a buttock image.

FIG. 7 is a diagram illustrating a method of arithmetically determining the buttock width.

FIG. 8 is a flow chart illustrating processing to be executed every day by the evaluation device.

FIG. 9 is a diagram illustrating another growth evaluation method.

FIG. 10 is a diagram illustrating still another growth evaluation method.

FIG. 11 is a diagram illustrating an overall view of the pig raising environment when a stereo camera is used.

FIG. 12 is a diagram illustrating a method of generating the buttock image when the stereo camera is used.

### DESCRIPTION OF EMBODIMENTS

The following will describe the present invention through an embodiment of the present invention, but is not intended to limit the invention related to the scope of claims to the following embodiment. In addition, not all the configurations described in the embodiment are indispensable as means for solving the problem.

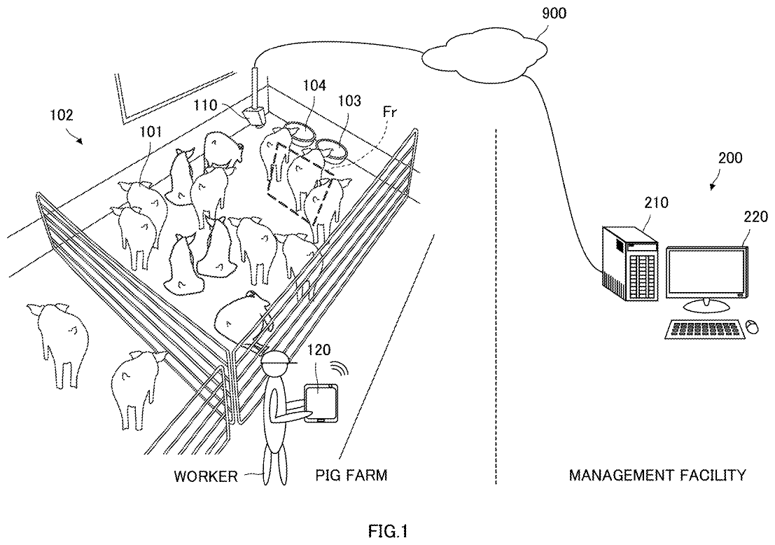

FIG. 1 is a diagram illustrating an overall view of a pig raising environment using an evaluation device 200 according to the present embodiment. The evaluation device 200 is an embodiment of a growth evaluation device. In a pig farm, pigs 101 to be observed are housed in a group in a pen 102. At a time when raising is started in the pen 102, these pigs 101 have comparable body frames, and are raised to grow until reaching shippable sizes. In other words, in principle, the housing and exit of the pigs 101 in and from the pen 102 is simultaneously performed on the group of the pigs 101. Accordingly, the pigs 101 housed in the pen 102 are managed as the group, and evaluation of the growth thereof described below is also performed on a per group basis. Note that the number of the pigs 101 raised in the pen 102 is, e.g., about 20, and can be adjusted depending on the breed of the pigs 101 or a raising environment.

A camera unit 110 includes an imaging sensor capable of overlooking and capturing an image of a predetermined position in the pen 102, converts a 2D image captured by the imaging sensor to image data, and transmits the image data to a server 210 via an Internet 900. The camera unit 110 is disposed so as to capture an image of, e.g., a range at an angle of view Fr at which the pigs 101 being fed with head portions thereof sticking into a food container 103 are overlooked from behind. The camera unit 110 thus disposed allows an image having buttocks of the pig 101 facing forward during feeding to be acquired.

The camera unit 110 is not limited to the case where the predetermined position is set in the vicinity of the food container 103. When it can be expected to capture an image of the buttocks of the pig 101 moving around in the pen 102 in a forwardly facing state, the predetermined position may also be set to such a place. For example, the predetermined position may also be in the vicinity of a water container 104. Since a feeding site and a watering site are places visited successively by the housed pigs 101, the feeding site and the watering site are convenient for random acquisition of the buttock images of the large number of pigs 101.

In a management facility, the evaluation device 200 that evaluates growth of the pigs 101 to be observed is disposed. The evaluation device 200 includes the server 210, a display monitor 220 connected to the server 210, and the like, and the server 210 is connected to the Internet 900. The server 210 receives the image data transmitted from the camera unit 110 via the Internet 900 and evaluates a degree of growth of all the pigs 101 housed in the pen 102 on the basis of the image data. The server 210 displays a result of the evaluation on the display monitor 220. When the evaluation result is requested by a worker working in the pig farm via a worker terminal 120, the evaluation result is displayed on a display unit of the worker terminal 120 via the Internet 900. Examples of the worker terminal 120 include a tablet terminal and a smartphone.

Note that a network connecting the camera unit 110 and the evaluation device 200 is not limited to the Internet 900, and may also be an intranet or the like. When the management facility is provided in the pig farm, near field communication may also be used.

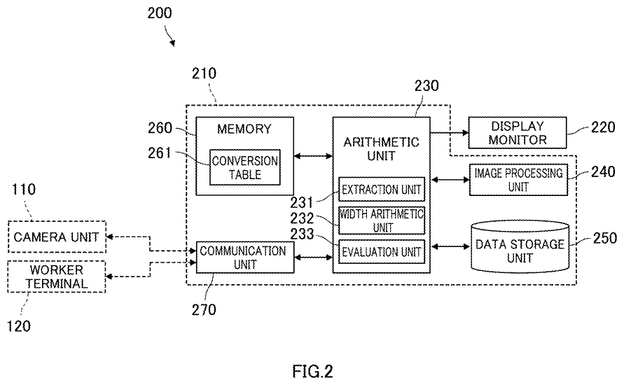

FIG. 2 is a diagram illustrating a hardware configuration of the evaluation device 200. As described above, the evaluation device 200 mainly includes the server 210 and the display monitor 220. The display monitor 220 includes, e.g., a liquid crystal panel, converts a video signal generated from an arithmetic unit 230 to a visually recognizable video, and displays the video. The server 210 mainly includes the arithmetic unit 230, an image processing unit 240, a data storage unit 250, a memory 260, and a communication unit 270.

The arithmetic unit 230 is, e.g., a CPU and executes various programs read from the memory 260 to control the entire evaluation device 200 or execute various arithmetic processing. For example, when executing processing as an extraction unit 231, the arithmetic unit 230 cooperates with the image processing unit 240 to extract, from the image transmitted from the camera unit 110, the buttock image having the buttocks of the pig 101 facing forward. When executing processing as a width arithmetic unit 232, the arithmetic unit 230 arithmetically determines, from the buttock image extracted by the extraction unit 231, a width of the buttocks of the pig 101 seen therein. When executing processing as an evaluation unit 233, the arithmetic unit 230 evaluates, on the basis of a prescribed number or more of the buttock widths arithmetically determined by the width arithmetic unit 232, the degree of growth of all the pigs 101 housed in the pen 102, and outputs a result of the evaluation to the display monitor 220 or the worker terminal 120. Specific processing will be described later in detail.

The image processing unit 240 is, e.g., an ASIC for image processing and executes image processing such as generating the buttock image by cutting out a buttock region of the target pig from the image data received from the camera unit 110. The data storage unit 250 is, e.g., an HDD (Hard Disc Drive) and stores the buttock width arithmetically determined from the buttock image and the like.

The memory 260 is, e.g., an SSD (Solid State Drive) and stores not only a control program for controlling the evaluation device 200 and a growth evaluation program for evaluating the degree of growth of the pigs 101, but also various parameter values, functions, a lookup table, and the like. In particular, a conversion table 261 that converts the buttock width to an estimated body weight is stored.

The communication unit 270 is, e.g., a wired LAN unit. The arithmetic unit 230 requests the image data from the camera unit 110 connected to the Internet 900 via the communication unit 270, and receives the image data transmitted from the camera unit 110 in response thereto. The evaluation unit 233 also transmits, in response to a request from the worker terminal 120 received via the communication unit 270, a result of the evaluation to the worker terminal 120.

When pigs are raised using a pen, the pigs housed in the pen are allowed to move relatively freely, which is preferable in terms of health management for the pigs. However, when the body weights of the pigs in the pen are to be measured for the purpose of determining shipment and checking the growth degrees, it has conventionally been required to guide the pigs one by one to a cage in which a weight scale is placed, which task has placed a burden on a worker. As a result of continuously studying a method that allows easier evaluation of a degree of growth of pigs housed in a pen, the present inventors have found that there is a strong correlation between a buttock width, which is a width of buttocks of a pig, and a body weight of the pig. It is generally assumed that there is a certain degree of correlation between any body region of a pig and a body weight thereof, and it has been found that the correlation between the buttock width and the body weight has less variation between individuals and is particularly stronger than a correlation between another region and the body weight. In addition, it has also been found that, when buttocks of a pig are used as an observation target, due to a position and a skin shape thereof, it is possible to precisely and easily perform analysis using an image.

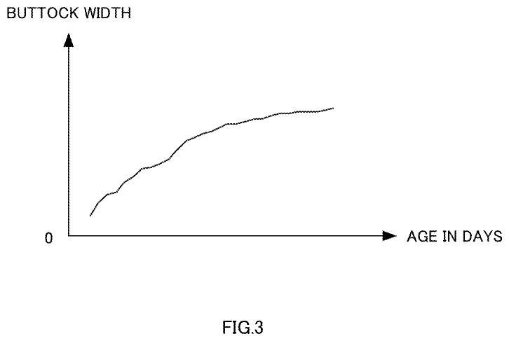

A description will be given of the correlation between the buttock width and the body weight. FIG. 3 is a graph illustrating a relationship between an age in days and a buttock width of a pig. The abscissa axis represents the age in days, while the ordinate axis represents the buttock width. The graph was obtained as a result of plotting the buttock widths (mm) measured at a fixed time every day from a time when the pigs to be observed were housed in a pen. The pig used as the observation target was in a satisfactory health condition during an observation period. As illustrated in the figure, the graph exhibits a curve which gradually increases substantially with the age in days, though slightly fluctuating.

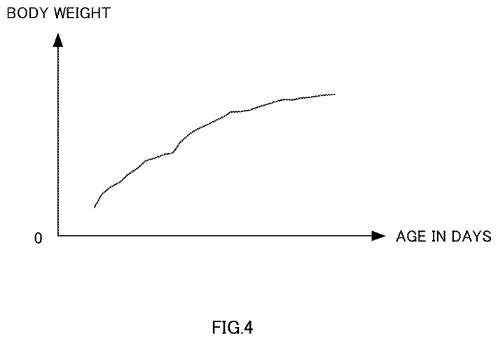

FIG. 4 is a graph illustrating a relationship between the age in days and body weight of the pig. The abscissa axis represents the age in days, while the ordinate axis represents the body weight. The graph was obtained as a result of plotting the body weights (kg) measured by placing the same pig as the observation target in FIG. 3 on a weight scale subsequently to the measurement of the buttock widths. As illustrated in the figure, the graph exhibits a curve which gradually increases substantially with the age in days, while showing a similar transition to that shown in the graph in FIG. 3.

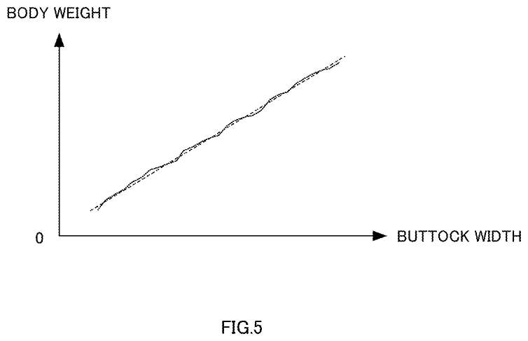

FIG. 5 is a graph illustrating a relationship between the buttock width and the body weight. The abscissa axis represents the buttock width, while the ordinate axis represents the body weight. A solid-line graph was obtained as a result of plotting values actually measured from the pig observed in FIGS. 3 and 4. A dotted-line graph is a regression line obtained by also statistically processing, as processing targets, values actually measured from another pig similarly observed. As illustrated in the figure, the body weight of the pig has a strong correlation to the buttock width, and it will be understood that the body weight can accurately be estimated from the buttock width. In other words, it will be understood that, when pigs of the same type are raised, as long as such a conversion formula or conversion table that converts the buttock width to the estimated body weight is produced in advance through experiment, it is possible estimate the body weight of the pig to be observed by measuring the buttock width thereof in subsequent raising.

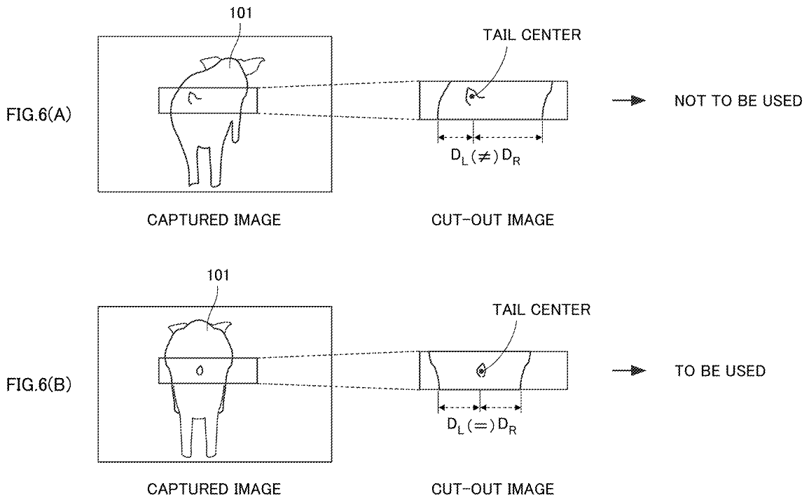

In the present embodiment, by using such a property, the growth degree of all the pigs 101 housed in the pen is evaluated on the basis of an average estimated body weight. A description will be given of a specific procedure thereof. First, as described above, captured images of the pigs 101 successively visiting the food container 103 are sequentially acquired from the camera unit 110, and buttock images having buttocks facing forward are extracted from among the captured images. FIG. 6 is a diagram illustrating the buttock images.

The extraction unit 231 causes the image processing unit 240 to generate cut-out images by cutting regions in the vicinities of tails from captured images of captured image data transmitted from the camera unit 110. Specifically, the image processing unit 240 performs matching processing using, e.g., a large number of template images prepared as tail images in advance to find tail regions in target images. Then, the extraction unit 231 cuts out the found tail regions and peripheries thereof into preset image sizes to generate the cut-out images. Note that each of the image sizes of the cut-out images is set to dimensions which allow even a body frame of a grown-up pig to fit in a width direction. To cut out the tails, it may also be possible to generate the cut-out images by using a learned model of, e.g., a CNN to which the captured image is to be input.

The extraction unit 231 performs edge processing on each of the cut-out images to calculate the number of pixels DL between a center of the tail and a left body boundary and the number of pixels DR between the center of the tail and a right body boundary. In the case of FIG. 6(A), the pig 101 faces an angle, and accordingly D_{L}≠D_{R} is satisfied. Therefore, it is determined that the buttocks do not face forward, and this cut-out image is not used as the buttock image. Meanwhile, in the case of FIG. 6(B), the pig 101 faces front, and accordingly D_{L}=D_{R} is satisfied. Therefore, it is determined that the buttocks face forward, and this cut-out image is used as the buttock image. In other words, the image in which the tail is located at a center of the buttocks in the width direction is extracted and used as the buttock image. Note that the extraction unit 231 determines whether or not D_{L} and D_{R} are equal in consideration of an allowable error set on the basis of the number of pixels along a lateral width of the cut-out image.

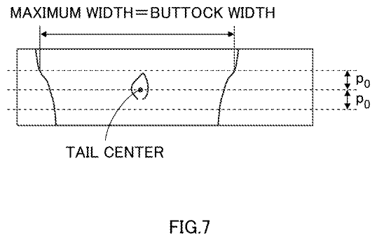

When the extraction unit 231 thus extracts the buttock image, the width arithmetic unit 232 arithmetically determines the buttock width of the pig 101 from the buttock image. FIG. 7 is a diagram illustrating a method of arithmetically determining the buttock width.

As described above, the center position of the tail is recognized by the extraction unit 231, and therefore the width arithmetic unit 232 determines a belt-shaped range interposed between a p₀ pixel range extending from the center position to a back side and a p₀ pixel range extending from the center position to a foot side to be a range in which the buttock width is to be detected. Then, the width arithmetic unit 232 horizontally counts the numbers of pixels between the left body boundary and the right body boundary in the belt-shaped range in succession, and determines a width at a horizontal position at which the counted number is maximum to be the buttock width. In other words, the width arithmetic unit 232 determines the maximum width in a predetermined range in which the center of the tail is at a center in a height direction to be the buttock width (pixels).

In the present embodiment, the camera unit 110 is disposed so as to face a predetermined position in the pen 102, and the buttocks of the pig 101 observed at the predetermined position are located at a substantially constant distance from the camera unit 110 during any photographing time. Accordingly, the real buttock width (mm) of the pig and the buttock width (pixels) determined from the buttock image correspond one-to-one to each other. Specifically, a conversion formula is established depending on the angle of view of the camera unit 110, an assumed distance to the buttocks of the pig, or the like. In other words, the buttock width (pixels) determined from the buttock image is converted by the established conversion formula to the real buttock width (mm). Then, the real buttock width can be converted by the conversion formula or conversion table illustrated in FIG. 5 to an estimated body weight (kg).

In the present embodiment, it is not intended to estimate not a body weight of a specified one of the pigs, but is intended to estimate an average body weight of all the pigs present in the pen 102. To calculate a precise average body weight, it is required to capture an image of the buttocks of each one of the pigs and arithmetically determine the buttock width. However, in the present embodiment, it is assumed that, at a time when raising is started in the pen 102, all the pigs have approximately the same body frames. Accordingly, when the prescribed number or more of the buttock widths of the pigs can randomly be arithmetically determined, it is possible to easily estimate the average body weight of the group. On the basis of such a way of thinking, the evaluation device 200 arithmetically determines the prescribed number or more of the buttock widths every day, aggregates the buttock widths, and outputs the average estimated body weight. A specific description will be given of a flow of the processing.

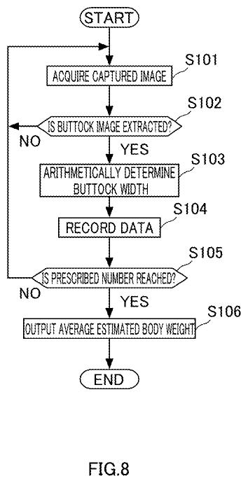

FIG. 8 is a flow chart illustrating processing to be executed by the evaluation device 200 every day. The flow is started at a preset time every day.

In Step S101, the arithmetic unit 230 transmits, to the camera unit 110, a signal representing an instruction to capture an image, and acquires image data of an image captured by the camera unit 110 in response thereto via the communication unit 270. As described using FIG. 6, the extraction unit 231 attempts to see whether or not the buttock image can be extracted from the acquired image data. When the buttock image cannot be extracted, the flow returns to Step S101. When the buttock image can be extracted, the flow advances to Step S103.

The width arithmetic unit 232 arithmetically determines the buttock width from the buttock image received from the extraction unit 231, as described using FIG. 7. Then, the width arithmetic unit 232 records a result thereof in the data storage unit 250. In Step S105, the evaluation unit 233 checks whether or not the number of the buttock widths recorded in the data storage unit 250 has reached the prescribed number. When the number of the buttock widths has not reached the prescribed number, the flow returns to Step S101. When the number of the buttock widths has reached the prescribed number, the flow advances to Step S106. Note that, even when the prescribed number has been reached, the flow may also be configured to return to Step S101 and allow collection the buttock widths to be continued during a predetermined period.

In Step S106, the evaluation unit 233 calculates an average value of the buttock widths recorded in the data storage unit 250, and uses the conversion table 261 read from the memory 260 to convert the average value of the buttock widths to the estimated body weight. Then, the evaluation unit 233 outputs the estimated body weight as the average estimated body weight of all the pigs 101 housed in the pen 102 to the display monitor 220 or the worker terminal 120. For example, a display such as “DATE MM-DD/PEN No. ______ /AVERAGE ESTIMATED BODY WEIGHT ______kg”, is made on the display monitor 220. When the outputting of the average estimated body weight is finished, the sequential processing is ended.

Note that a time block in which the processing described above is to be executed every day is preferably set to a feeding time block in which the pigs 101 are fed or to a working time block in which the worker works in the pen 102. During a feeding time, the pigs 101 housed in the pen 102 successively visit the food container 103, and consequently a large number of the buttock images can be randomly obtained. During a working time, the pigs 101 housed in the pen 102 are caused to move around, and consequently a large number of the buttock images can also be randomly obtained conveniently.

In the foregoing embodiment described heretofore, the evaluation unit 233 evaluates a degree of growth of all the pigs 101 housed in the pen 102 as the average estimated body weight on the evaluation day. However, it is possible to figure out a method of evaluating the growth degree of all the pigs 101 housed in the pen 102 without using the average estimated weight. A description will be given below of several evaluation methods.

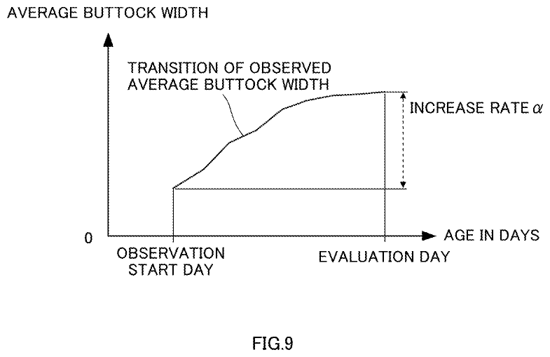

FIG. 9 is a diagram illustrating another growth evaluation method, which is a graph illustrating a relationship between the age in days of each of the pigs and the average buttock width of the pigs 101 housed in the pen 102. The abscissa axis represents the age in days, while the ordinate axis represents the average buttock width. The graph is obtained as a result of plotting the average buttock widths measured at a fixed time every day from the observation start day on which the pigs 101 to be observed were housed in the pen to the evaluation day.

To output the average estimated body weight as in the embodiment described above, time and labor is required to preliminarily produce the conversion formula or conversion table that converts the buttock width to the estimated body weight for each group of the pigs of the same type through experiment. Accordingly, in the present evaluation method, this time and labor is omitted, and the degree of growth of all the pigs 101 is evaluated on the basis of an increase rate of the average buttock width.

Specifically, the prescribed number or more of the buttock widths are arithmetically determined every day to be aggregated, and an average value thereof is recorded as the average buttock width on the day. Then, the evaluation unit 233 calculates a rate at which the average buttock width observed on the day has increased relative to the average buttock width on the observation start day, and outputs the increase rate α as the growth degree. Since the system operator and the worker empirically knows when it is time to ship on the basis of at which value approximately the increase rate α reaches, such mere outputting of the increase rate α from the evaluation device 200 may result in an evaluation of the growth degree of all the pigs 101. In particular, as long as the respective body weights of the pigs 101 are measured at the time when raising is started in the pen 102 and the evaluation device 200 acquires the measured body weights, it is possible to evaluate the growth degree on the basis of the total body weight at the raising start time and the increase rate α. The evaluation device 200 can output, as, e.g., a current estimated body weight, a value obtained by multiplying the total body weight at the raising start time by the increase rate α. The evaluation device 200 may also be configured such that the body weight at the raising start time is input by the worker via an input device of the evaluation device 200 or is automatically acquired in association with a body weight scale. In this case, in the evaluation device 200, the input device or an automatic acquisition interface has a function of an acquisition unit that acquires the body weights of the plurality of pigs.

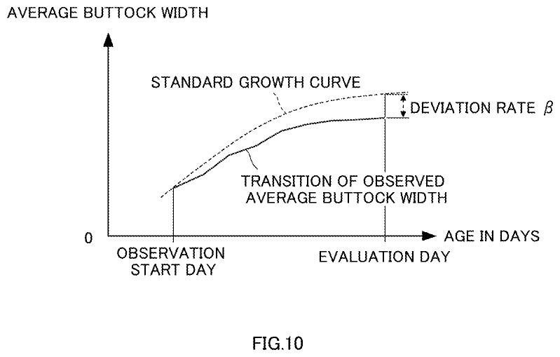

FIG. 10 is a diagram illustrating still another growth evaluation method, which is a graph illustrating a relationship between the age in days of each of the pigs and the average buttock width of the pigs 101 housed in the pen 102. The abscissa axis represents the age in days, while the ordinate axis represents the average buttock width. A solid-line graph was obtained as a result of plotting the average buttock widths measured at a fixed time every day from the observation start day on which the pigs 101 to be observed were housed in the pen to the evaluation day. A dotted-line graph is a growth curve representing a transition of a standard average buttock width. The growth curve was obtained by plotting, e.g., average values calculated from a result of observing pigs previously raised in the same pen 102.

The evaluation unit 233 calculates a rate at which the average buttock width observed on the evaluation day deviates from the standard growth curve, and outputs a resulting deviation rate β as the growth degree. Since the system operator and the worker knows a certain approximate value of the deviation rate at which steady growth can be determined, such mere outputting of the deviation rate _{R} from the evaluation device 200 may result in an evaluation of the growth degree of all the pigs 101. When the deviation rate β increases, the system operator or the worker can take appropriate measures, such as investigation of a cause thereof. Note that, in the same manner as in the example in FIG. 9, as long as the total body weight of the pigs 101 was successfully acquired at the raising start time, it is possible to evaluate the growth degree on the basis of the total body weight at the raising start time and the deviation rate β. By evaluating the deviation rate β on the basis of, e.g., the total body weight at the raising start time and the age in days, the evaluation device 200 can output warning information.

In the present embodiment described heretofore, the camera unit 110 set to capture an image at a relatively small angle of view Fr at which the food container 103 or the like is overlooked is used. In addition, since the camera unit 110 outputs a 2D image, on the assumption that a distance from the camera unit 110 to the buttocks of each of the pigs is maintained at a given distance, the buttock width (pixels) determined from the buttock image is converted to the real buttock width (mm) of the pig. However, when a camera unit capable of outputting a distance image is used as the camera unit 110, it is also possible to extract a larger number of the buttock images without being constrained by such assumptions. As the camera unit that outputs a distance image, a stereo camera, a TOF camera, or the like can be used, and a description will be given herein of a case where the stereo camera is used.

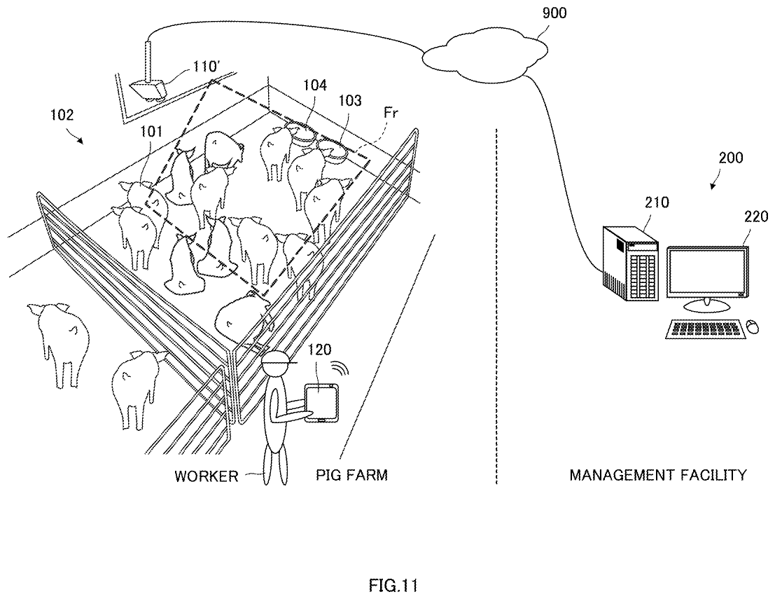

FIG. 11 is a diagram illustrating an overall view of a pig raising environment when a camera unit 110′ having an embedded stereo camera is used. A configuration illustrated in FIG. 11 is different from the configuration illustrated in FIG. 1 in that the camera unit 110′ uses the stereo camera and that the angle of view Fr corresponding to an image capturing range is larger. Due to the larger angle of view Fr, the camera unit 110′ can simultaneously capture images of a larger number of the pigs 101.

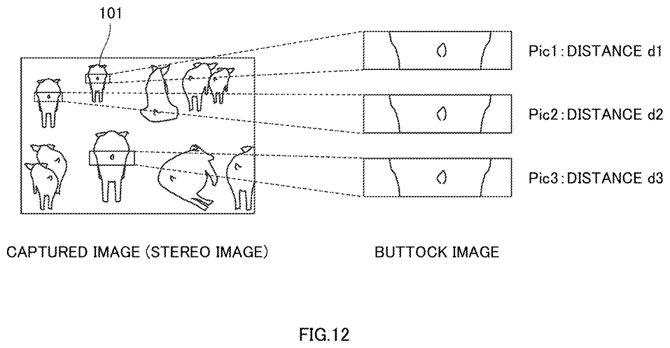

FIG. 12 is a diagram illustrating a method of generating a buttock image when the camera unit 110′ is used. In most cases, in images captured by the camera unit 110′, the large number of pigs 101 are seen. Accordingly, the extraction unit 231 cuts out all the buttock regions of the pigs 101 in which the buttocks face forward from one of stereo images. Specifically, in the same manner as in the method described using FIG. 6, image regions in which the tails are located at the centers of the buttocks in the width direction are cut out to be used as the buttock images. At this time, an image size of each of the cut-out images is not a fixed size, and is individually adjusted such that the left and right body boundaries of each of the pigs are included therein.

For example, when three buttock images Pic1 to Pic3 are extracted as illustrated in the figure, the extraction unit 231 cuts out respective regions corresponding thereto from another of the stereo images. Then, using an amount of displacement between the corresponding two buttock images, the extraction unit 231 calculates distances d1, d2, and d3 from the camera unit 110′ to the individual buttocks.

The width arithmetic unit 232 arithmetically determines the buttock widths from the one stereo image as described using FIG. 7, and uses the individual distances to correct the arithmetically determined buttock widths to buttock widths corresponding to a standard distance do (e.g., 1 m). When such a correction is made, the buttock widths can uniformly be compared and verified. Accordingly, the evaluation unit 233 can convert each of the buttock widths to the estimated body weight by using the conversion formula or conversion table produced under the assumption of the standard distance do. Alternatively, the evaluation unit 233 can calculate the increase rate a or the deviation rate β. Moreover, since a large number of buttock images can be extracted from one captured image, the growth degree can be evaluated within a shorter period of time or with higher accuracy.

### REFERENCE SIGNS LIST

101 Pig
102 Pen
103 Food container
104 Water container
110, 110′ Camera unit
120 Worker terminal
200 Evaluation device
210 Server
220 Display monitor
230 Arithmetic unit
231 Extraction unit
232 Width arithmetic unit
233 Evaluation unit
240 Image processing unit
250 Data storage unit
260 Memory
261 Conversion table
270 Communication unit
900 Internet

What is claimed is:

1. A growth evaluation device comprising:
an extraction unit that extracts, from an image captured by a camera disposed to face a pen in which a plurality of pigs are raised in a group, a buttock image having buttocks of one of the pigs facing forward;
an arithmetic unit that arithmetically determines a buttock width from the buttock image; and
an evaluation unit that evaluates a degree of growth of all the plurality of pigs on the basis of a prescribed number or more of the buttock widths arithmetically determined by the arithmetic unit.

2. The growth evaluation device according to claim 1, wherein the evaluation unit converts each of the buttock widths to an estimated body weight and outputs an average estimated body weight of the plurality of pigs.

3. The growth evaluation device according to claim 1, further comprising:
an acquisition unit that acquires body weights of the plurality of pigs at a time when raising is started in the pen, wherein
the evaluation unit evaluates the degree of growth on the basis of the body weights and changes over a given period in the prescribed number or more of the buttock widths arithmetically determined by the arithmetic unit.

4. The growth evaluation device according to claim 1, wherein
the extraction unit extracts, as the buttock image, an image having a tail located at a center of the buttocks in a width direction, and
the arithmetic unit arithmetically determines, as the buttock width, a maximum width in a predetermined range in which the tail is at a center in a height direction.

5. The growth evaluation device according to claim 1, wherein the image is a 2D image output from the camera disposed to face a predetermined position in the pen.

6. The growth evaluation device according to claim 5, wherein the predetermined position is at least one of the feeding site and the watering site placed in the pen.

7. The growth evaluation device according to claim 1, wherein
the image is a distance image output from the camera, and
the arithmetic unit corrects the buttock width on the basis of a distance from the camera to the buttocks of the pig seen in the image.

8. The growth evaluation device according to claim 1, wherein the image is an image captured during a feeding time during which the plurality of pigs are fed.

9. The growth evaluation device according to claim 1, wherein the image is an image captured during a working time during which a worker works in the pen.

10. A growth evaluation method comprising:
an extraction step of extracting, from an image captured by a camera disposed to face a pen in which a plurality of pigs are raised, a buttock image having buttocks of one of the pigs facing forward;
an arithmetic step of arithmetically determining a buttock width from the buttock image; and
evaluating a degree of growth of all the plurality of pigs on the basis of a prescribed number or more of the buttock widths arithmetically determined in the arithmetic step.

11. A growth evaluation program for causing a computer to execute:
an extraction step of extracting, from an image captured by a camera disposed to face a pen in which a plurality of pigs are raised, a buttock image having buttocks of one of the pigs facing forward;
an arithmetic step of arithmetically determining a buttock width from the buttock image; and
an evaluation step of evaluating a degree of growth of all the plurality of pigs on the basis of a prescribed number or more of the buttock widths arithmetically determined in the arithmetic step.
